(19) United States
(12) Patent Application Publication
(10) Pub. No.: US 2026/0261732 A1
(43) Pub. Date: Sep. 3, 2026

(54) ATTENTION PREDICTION BASED ON GAZE ESTIMATION

(71) Applicant: The Nielsen Company (US), LLC, New York, NY (US)

(72) Inventors: Ronny Lerch, Decatur, GA (US); Evin Aslan Oguz, Ljubljana (SI); Meryem Berrada, Tampa, FL (US)

(21) Appl. No.: 19/654,399

(22) Filed: Apr. 21, 2026

Related U.S. Application Data
(63) Continuation of application No. PCT/US24/52364, filed on Oct. 22, 2024.
(60) Provisional application No. 63/592,570, filed on Oct. 23, 2023.

(51) Int. Cl. H04N 21/442; G06F 3/01; G06T 17/20; G06V 10/25; G06V 20/70

(52) U.S. Cl. CPC H04N 21/44218; G06F 3/013; G06T 17/20; G06V 10/25; G06V 20/70

(57) ABSTRACT

An example method includes capturing, with a camera collocated with presented visual media content, an image of a person. Further, the example method includes obtaining, based the captured image, a rotational-data tuple representing a direction of gaze of the person in relation to a position of the camera, as depicted by the image. Still further, the example method includes providing, to a machine-learning model, the rotational data, the machine-learning model having been configured by training data that labels each of a plurality of test rotational-data tuples respectively with an indication of whether the test rotational-data tuple represents attentiveness or rather non-attentiveness. And the example method further includes obtaining, from the machine-learning model, based on the provided rotational-data tuple, a prediction of whether the person as depicted in the captured image was attentive to the presented visual media content or was rather non-attentive to the presented visual media content.

### CROSS-REFERENCE TO RELATED APPLICATIONS

This disclosure is a continuation of International Patent Application No. PCT/US2024/52364, filed Oct. 22, 2024, which claims priority to U.S. Provisional Patent Application No. 63/592,570, filed Oct. 23, 2023, each of which are hereby incorporated by reference herein in its entireties.

### BACKGROUND

In order to measure the extent to which people of various demographics are exposed to visual media content, including but not limited to content presented by media-presentation devices such as televisions, computers, tablets, phones, gaming devices, and others, an audience-measurement company may arrange to have people report time periods when they are viewing such content and/or may arrange to have media-monitoring devices or “meters” monitor time periods when such content is presented and when particular people are viewing the content. The audience-measurement company may then establish associated media-exposure data correlated with pre-stored demographics and may use the data as a basis to establish ratings statistics that may facilitate commercial processes such as ad placement or other content delivery.

### SUMMARY

Even if an audience-measurement company receives a report or other data indicating that a person viewed visual content for a particular period of time, it is possible that the person was not actually viewing the visual content for that entire time. For instance, it is possible that the person was distracted and/or otherwise looking away from the visual content at times throughout the indicated time period. Unfortunately, however, as a result, the media-exposure data established by the audience measurement company based on that data may therefore be inaccurate.

For at least this reason, it may be useful to determine when a person is actually looking at visual media content and thus when the user is attentive to the content, rather than looking away and thus not attentive to the content.

Knowledge of when a person is actually looking at presented visual media content may provide the technical advantage of helping to facilitate more accurate audience-measurement and thus to facilitate associated control over processes based on the audience measurement.

Further, knowledge of when a person is actually looking at presented visual media content may offer many other technical benefits as well. For instance, a computing system may be configured to respond to whether or not a person is looking at presented visual content by automatically adjusting brightness or associated lighting of or on the presented visual content (e.g., making a display of visual content brighter in response to a person looking at the content and darker when the person is not looking at the content) and/or by automatically adjusting the visual content or its environment in another manner. Further, detecting when a person is actually looking at presented visual content may facilitate confirming that the person is viewing the visual content, for educational tracking or other purposes, among other possibilities.

The present disclosure provides a technical mechanism to facilitate detecting whether a person is attentive to presented visual media content. In accordance with the disclosure, a computing system will use a trained machine-learning model to predict whether a person is attentive to visual media content, with the machine-learning model having been trained based on geometric data associated with head pose and facial landmarks in correlation with levels of attentiveness. For instance, a camera collocated with the visual media content (e.g., coplanar with a display presenting the content) may capture an image of the person's head including the person's face, the computing system may obtain certain geometric attributes from the captured image, and the computing system may provide the geographic attributes to the trained machine-learning model and receive as output from the model a prediction of whether the person is attentive to the visual media content. Further, the computing system may repeat this process over time as a basis to monitor when and to what extent the person is attentive, and therefore as a basis to establish associated audience-measurement data.

In an example implementation, the trained machine-learning model may be especially lightweight and therefore able to efficiently predict attentiveness in real time without unduly burdening processor resources, power resources, or data-storage resources. As a result, the trained machine-learning model may be implemented on a device such as a smartphone, tablet computer, headset or the like that may have limited processor, limited power, and/or limited data-storage capacity.

Furthermore, in the example implementation, the trained machine-learning model may be robust enough to predict a person's attentiveness to presented visual media content without a need to initially calibrate, configure, or otherwise train the model based on images of that person's head and face in particular (for instance, without requiring the person to look in various different directions as a basis to calibrate the model.) Thus, in the example implementation, the trained machine-learning model may work right out of the box.

In one respect, disclosed is a method. The method includes capturing, with a camera collocated with presented visual media content, an image of a person. Further, the method includes obtaining, based on the captured image, a rotational-data tuple representing a direction of gaze of the person in relation to a position of the camera, as depicted by the image. Still further, the method includes providing, to a machine-learning model, the rotational data, the machine-learning model having been configured by training data that labels each of a plurality of test rotational-data tuples respectively with an indication of whether the test rotational-data tuple represents attentiveness or rather non-attentiveness. And the method includes obtaining, from the machine-learning model, based on the provided rotational-data tuple, a prediction of whether the person as depicted in the captured image was attentive to the presented visual media content or was rather non-attentive to the presented visual media content.

In another respect, disclosed is a computing system including at least one processor, non-transitory data storage, and program instructions stored in the non-transitory data storage and executable by the at least one processor to cause the computing system to carry out operations such as those of the above method for instance.

In yet another respect, disclosed is non-transitory computer-readable data storage, having stored thereon program instructions executable by at least one processor of a computing system to carry out operations such as those of the above method for instance.

In yet another respect, disclosed is a computer program comprising program instructions executable by at least one processor of a computing system to perform operations such as those of the above method for instance.

### BRIEF DESCRIPTION OF THE DRAWINGS

FIG. 1 is an illustration of a person viewing presented visual media content and an image being captured of the person.

FIG. 2 is an illustration of example rotational angles in the captured image of FIG. 1.

FIG. 3 is an example image with a face mesh.

FIG. 4 is a portion of a captured image, depicting example facial landmarks.

FIG. 5 is an illustration of an eye box that a computing system may programmatically establish as a basis to generate rotational data.

FIG. 6 is an illustration of example viewing points for purposes of training a machine-learning model to predict attentiveness to presented visual media content.

FIG. 7 is a simplified graph showing an example rotational-data threshold between attentiveness and non-attentiveness.

FIG. 8 is simplified block diagram illustrating reporting of viewing data in view of an attentiveness prediction.

FIG. 9 is a flow chart illustrating an example method.

FIG. 10 is a simplified block diagram of an example computing system.

### DETAILED DESCRIPTION

This description will discuss example implementation in relation to detecting a person's attentiveness to visual media content that is presented on a display panel of a handheld smartphone (or more generally detecting a person's attentiveness to a display panel of a handheld smartphone), based on an image of the person as captured by a front facing-camera of the smartphone. It should be understood, however, that the disclosed principles could also apply in many other contexts. By way of example, similar principles could apply to detect a person's attentiveness to visual media content presented on a computer monitor based on an image of the person captured by a webcam in or on the computer monitor. As another example, similar principles could apply to detect a person's attentiveness to artwork such as a painting or sculpture, based on an image of the person captured by a camera collocated with the artwork. Numerous other examples are possible as well.

One potential approach for gauging a person's level of attentiveness to presented visual media content is to take into account the position and size of the person's eyes in a captured image. Unfortunately, however, there can be a lot of variation in eye shape from person to person, based on factors such as shape of the upper eyelid, shape and position of the upper eyelid crease, presence of an epicanthic fold at the inner corner of the eye, prominence of the brow bone, position and visibility of the tear duct, and angle and position of the outer corner of the eye. Therefore, it could be difficult to configure a machine-learning model to account for these and other variations in a manner that may be broadly applicable.

As presently contemplated, an improved technical approach is to base the process on some relatively simple geometric characteristics that are common to most people, thereby inherently normalizing and simplifying the analysis. In particular, the present approach provides for basing the attentiveness analysis on a comparison of head pose with gaze direction. A theory here is that, given a knowledge of head pose in relation to the presented visual media content (e.g., the display plane), the direction of gaze in relation to the head pose can establish direction of gaze in relation to the presented visual media content, which may in turn establish level of attentiveness. Through machine-learning, this geometric data can thus be correlated with level of attentiveness.

In an example implementation, a computing system will obtain facial landmark data based on a 2-dimensional (2D) image of a person viewing presented visual media content, and the computing system will use the facial landmark data as a basis to ultimately determine up-down (pitch) and left-right (yaw) rotational angles of the person's gaze in relation to the presented visual media content. The computing system will then provide these rotational angles to a trained machine-learning model, such as a decision tree, and may obtain from the machine-learning model, based on the provided rotational angles, a prediction whether the person as represented by the 2D image was attentive to the presented visual media content. The computing system may then make use of this prediction. For instance, the computing system may generate exposure data indicating the prediction and may use the prediction, or provide the prediction for use, as a basis to establish ratings data, to control further media presentation, and/or for other useful purposes.

In the example implementation, the computing system may be the smartphone as noted above, with the camera being a front-facing camera of the smartphone. In particular, the camera may be coplanar with a display panel of the smartphone, having an optical axis extending in a direction that is perpendicular to the plane of the display panel. In this implementation, the computing system may comprise a processor of the smartphone, non-transitory data storage of the smartphone, and program instructions stored in the non-transitory data storage and executable by the processor to carry out various computing system operations as described herein.

In alternative implementations, the computing system may be separate from the smartphone and may operate on an image and/or associated data captured by the smartphone. For instance, the computing system may be a cloud-based platform or other computing system or device and may receive from the smartphone or from another entity a set of facial landmark data derived from the image and may operate on that data as a basis to predict whether the depicted user was attentive to the presented visual media content.

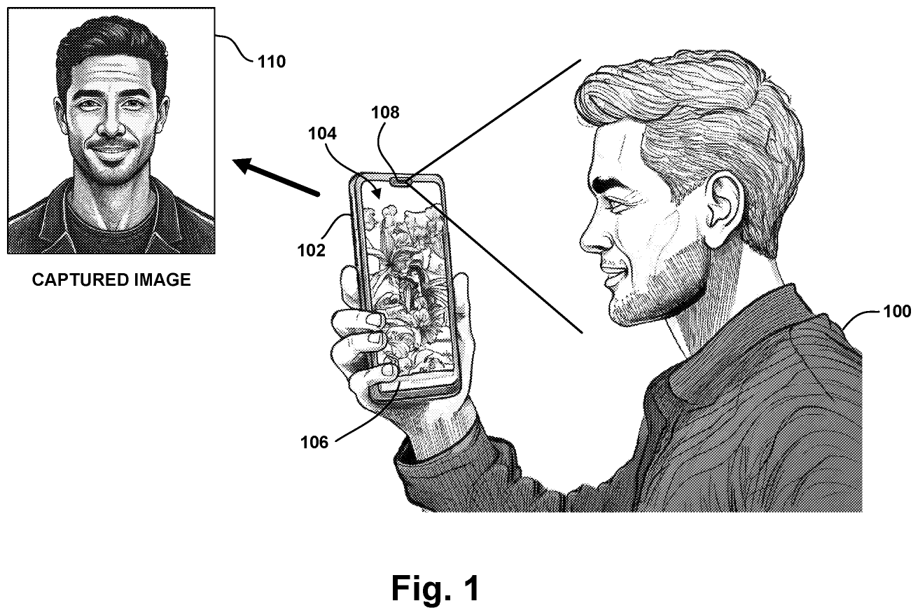

FIG. 1 illustrates an example scenario where a person 100 is holding an example smartphone 102, with visual media content 104 being presented on a display 106 of the smartphone 102, and with a front-facing camera 108 of the smartphone capturing an image 110 of the person 100. The captured image 110 in this example shows the person 100 looking straight at the presented visual media content 104. In other examples, the captured image may show the person 100 looking at a different direction, possibly not straight on, perhaps more toward a side or up or down, among other possibilities.

With this arrangement, if the person 100 is looking at the presented visual media content 104 as shown, the resulting captured image 110 may thus depict the person 100 looking generally ahead as shown, suggesting that the person 100 is generally attentive to the presented visual media content 104. Whereas, if the person 100 is looking away from the presented visual media content 104 or is otherwise not particularly attentive to the presented visual media content 104, the resulting captured image 110 may depict the person 100 looking in another direction, suggesting that the person 100 is generally not attentive to the presented visual media content 104. For present purposes, the camera 108 and/or smartphone 102 could be considered part of the presented visual media content 104, so the person's gaze toward the camera 108 for instance may represent the person 100 looking toward the presented visual media content 104.

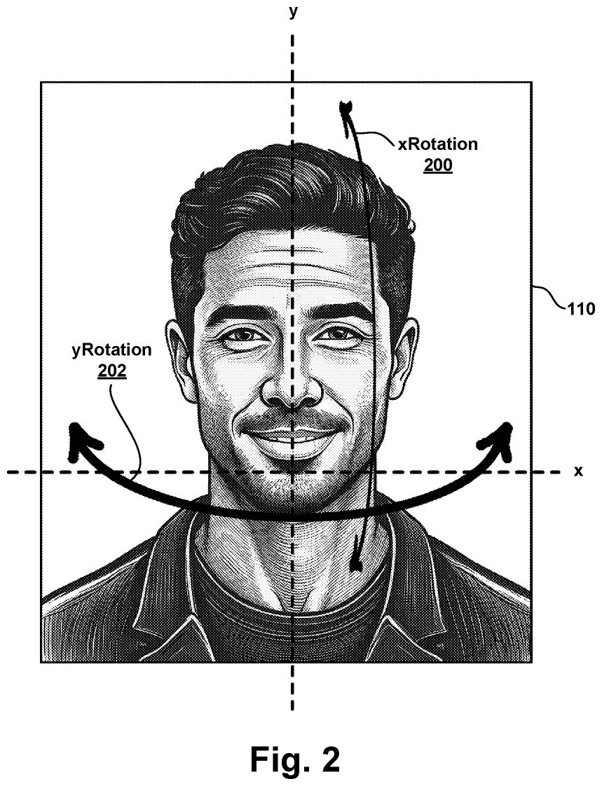

In the example implementation, the computing system may evaluate the captured image to programmatically determine the up-down (pitch) and left-right (yaw) rotational angles of the person's gaze in relation to the camera 108, e.g., relative to the optical axis of the camera 108. FIG. 2 illustrates these angles in the context of the example image 110, again understanding that the captured image and associated gaze direction may differ from that illustrated.

As shown in FIG. 2, in 2D space, the image 110 defines x and y Cartesian coordinates. The up-down (pitch) rotational angle is then shown as being an angle of rotation about a horizontal x axis, also referred to as xRotation 200, and the left-right (yaw) rotational angle is shown as being an angle of rotation about a vertical y axis, also referred to as yRotation 202.

The computing system will determine the xRotation 200 and the yRotation 202 based on a programmatic analysis of facial landmarks within the image 110, where each facial landmark corresponds with a particular facial feature and has a particular location in the x-y Cartesian coordinate space of the image 110. The computing system could apply any of various techniques to establish the facial landmarks. Without limitation, for instance, the computing system could use a face mesh model such as the MediaPipe Landmarker, which is available through an application programming interface (API) on the internet.

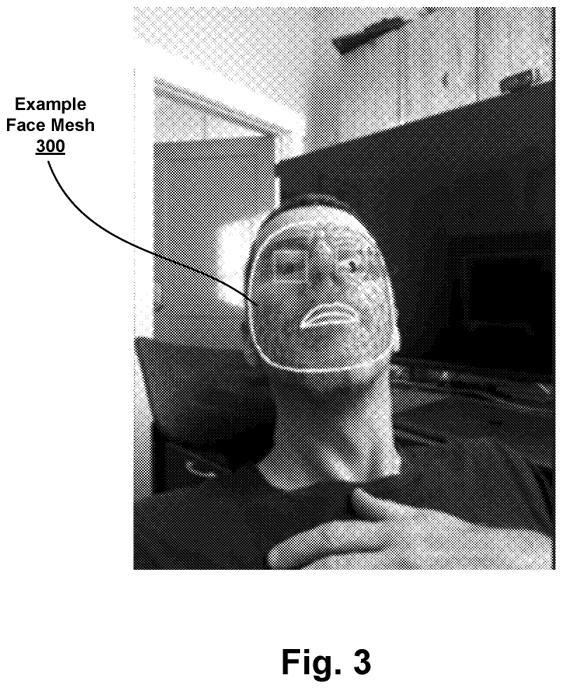

Through use of the MediaPipe Landmarker, for instance, the computing system could receive a face mesh that defines various facial features and associated coordinates in the Cartesian space. FIG. 3 illustrates an example of such a face mesh. More particularly, the face mesh model may provide the computing system with a set of data that identifies each of numerous facial landmarks by a respective code number and that specifies the Cartesian coordinates of the facial landmarks in the image 110.

The computing system may use this face mesh as a basis to determine head pose of the person 100 from the perspective of the camera 108. Head pose defines rotational angles in three directions, namely, pitch, yaw, and roll, known as Euler angles. Consistent with the terminology above, pitch defines angle of rotation about a Cartesian x axis, yaw defines angle of rotation about a Cartesian y axis, and roll defines angle of rotation about a Cartesian z axis (an axis perpendicular to the plane of the image 110). From the perspective of the camera 108, if the person's head is not tilted in any of these dimensions, these three angles may be zero.

The computing system could apply any of various techniques to establish head pose based on the face mesh. For instance, the computing system could apply the known Rodrigues rotation formula, with a Rodrigues matrix that results in a rotation vector with the pitch, yaw, and roll of the person's head in relation to the camera 108, as depicted by the image 110. Alternatively, the computing system may receive this head pose information as part of the face-mesh data or in another manner.

Further, the computing system may use the face mesh as a basis to determine the xRotation and yRotation of the person's gaze in relation to the camera, in a manner that effectively takes into account a comparison between the person's head pose and a direction of gaze in relation to that head pose.

The computing system may perform this analysis with respect to just one of the person's eyes. The computing system could select one of the eyes for this purpose, based on the selected eye being larger than the other eye, which may represent the selected eye being closer to the camera than the other eye, as that closeness may help improve accuracy of the analysis. Alternatively, if only one of the eyes is fully visible in the image 110 for present purposes, the computing system could select that eye on that basis. Still alternatively, the computing system could randomly select one of the person's eyes for this analysis. Yet alternatively, the computing system may perform this whole process respectively for each of the person's eyes, to help bolster the attentiveness conclusion (e.g., drawing a conclusion if the computing system comes to the same result for both eyes).

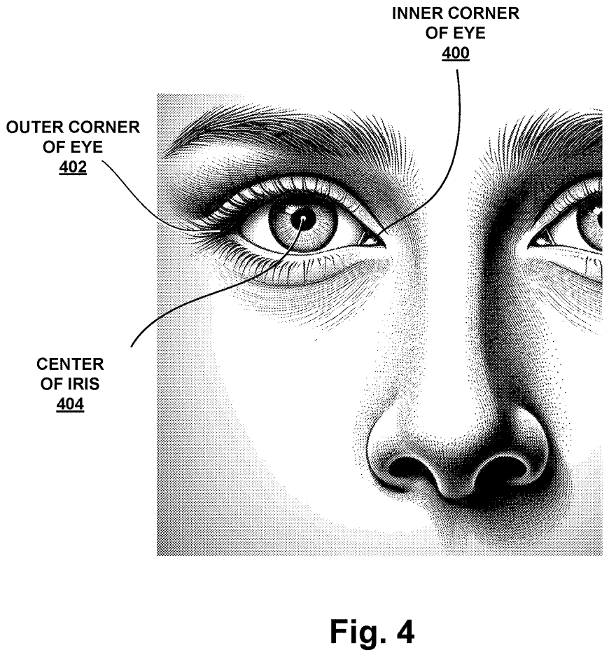

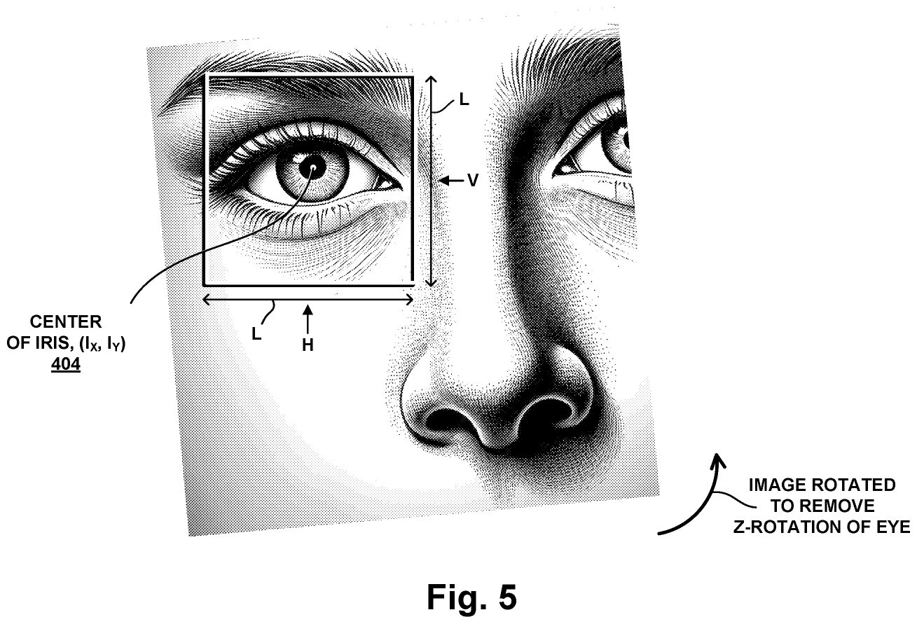

For this analysis, the computing system can make use of certain geometric features in the 2D coordinate space of the image, with these features being indicated by or derived from the facial mesh. These geometric features relate to the eye at issue and particularly to the relative position of the person's iris within that eye, because this relative position of the iris indicates a direction of the person's gaze relative to the person's head pose. FIGS. 4 and 5 illustrate bases for these geometric features with respect to an example eye (here, a person's right eye), which is again merely shown by way of example as looking straight forward but could alternatively be looking in another direction.

Three geometric features that the computing system can use in its analysis include (i) the x-y coordinates of the inner corner of the eye 400, (ii) the x-y coordinates of the outer corner of the eye 402, and (iii) the x-y coordinates of the center of the iris. The face-mesh data based on the 2D image of the person's face may specifically identify these geometric features. Alternatively, the face-mesh data may provide other data that the computing system can transform into one or more of these features. For instance, the face-mesh data may specifically identify the x-y coordinates respectively of the inner and outer corners of the eye but may specify four sets of x-y coordinates surrounding the iris 400 rather than specifying coordinates of the center of the iris, in which case the computing system may translate the iris-surrounding coordinates into coordinates of the center of the iris 404, such as by averaging the iris-surrounding coordinates for instance.

As shown in FIG. 5, the computing system may programmatically consider aspects of an eye box 500, or bounding box, that bounds the eyeball of the eye at issue.

To establish this eye box, the computing system may first deem a width of the eyeball in 2D space to be approximately the distance between the inner and outer corners of the eye 400, 402, adjusted to account for the skin that typically overlies the outer corner of the eye 402. To establish this width, the computing system may rotate the image 110 and all associated face mesh coordinates so that the inner and outer corners of the eye 400 are at the same Cartesian coordinate as each other. (In an example implementation, if the head pose includes a non-zero roll angle, i.e., if the person's head is tilted about the Cartesian z axis, the computing system could rotate the image to remove that z rotation. Further, the computing system could further rotate the image to horizontally level the eye box.) Further, the computing system could compute the geometric difference between the coordinates of the inner corner of the eye 400 and the coordinates of the outer corner of the eye 402 and could then reduce the result by 10% or some other amount to account for the skin covering. The result could be a relatively good approximation of the width of the eyeball, which the computing system can deem to be the width of the eye box, extending from the inner corner of the eye 400 horizontally outward.

In addition, the computing system may consider the eyeball to be generally spherical (as an approximation) and may therefore treat the height of the eyeball in 2D space to be the same as the width of the eyeball in 2D space. Thus, the computing system may deem the eye box 500 to be a square with sides having a length, L, equal to the determined width of the eyeball. Further, the computing system may initially deem the eyeball to be vertically centered at the level of the inner corner of the eye 400. Therefore, the computing system may initially establish the eye box 500 as shown in FIG. 5 to be a square whose right side (for this eye) has a vertical center, V, at the coordinates of the inner corner of the eye 400.

The computing system may further adjust the vertical position of the eye box 500 based on any up-down rotation (pitch) of the person's head, namely, based on the determined Euler pitch angle of the head pose, referred to as the eulerAngleX. A theory here is that, when a person tilts their head up (back), the person's eyeball may move slightly upward in the Cartesian y dimension in 2D space, and when a person tilts their head down, the person's eyeball may move slightly downward in the Cartesian y dimension in 2D space. To improve accuracy of the present process, the computing system may therefore account for the eulerAngleX as a basis to possibly shift the vertical position of the eye box 500.

In an example implementation, the computing system may control vertical shifting of the eye box based on the eulerAngleX of the head pose by (i) computing a common divider value, D, based on the value and direction of eulerAngleX, and (ii) computing a new vertical center, V_{new}, of the eye box based on the box size, L, the common divider value, D, and the current vertical center, V, of the eye box.

For instance, the computing system could compute the common divider value, D, as follows:

$$D = 1 - ( ( \frac{eulerAngleX}{divisor} ) \times direction )$$

where “divisor” is a value such as 200, 210, 230, or 240 that may produce good results in testing, and where “direction” is either plus or minus 1 based on the direction of head tilt, namely +1 if the angular direction of the eulerAngleX is downward or −1 if the angular direction of the eulerAnglex is upward. With this equation, if the eulerAngleX is zero, the divider value D would be 1, whereas if the eulerAngleX is non-zero, the divider value D would be greater than 1.

The computing system could then compute the new vertical center, V_{new}, of the eye box as follows:

$${V}_{new} = V - \frac{L}{2 D} + \frac{L}{2}$$

In effect, this equation determines a new top coordinate of the eye box to be up from the current vertical center, V, by L/2D and determines the new vertical center of the eye box to be half of the eye box size, L, down from that new top coordinate. Note that if the eulerAngleX is zero and the common divider is therefore 1, this equation would put the vertical center at V.

Given this new vertical center, V_{new}, of the eye box, the computing system could then compute the xRotation of the person's gaze in relation to the camera 108 as follows, based on a comparison of the vertical center, V_{new}, of the eye box with the Cartesian y coordinate of the center of the iris, I_{y}, namely:

$$xRotation = \frac{{I}_{y} - {V}_{new}}{eyeRadius} = ( {I}_{y} - {V}_{new} ) / ( \frac{L}{2} )$$

Further, the computing system could compute the yRotation of the person's gaze in relation to the camera 108 as follows, based on a comparison of the horizontal center, H, of the eye box with the Cartesian x coordinate of the center of the iris, Iₓ, namely:

$$yRotation = ( \frac{{I}_{x} - H}{eyeRadius} ) \times ( - 1 ) = ( \frac{{I}_{x} - H}{\frac{L}{2}} ) \times ( - 1 )$$

In line with the discussion above, the computing system could use these determined xRotation and yRotation values as a basis to determine whether the person 100 depicted in the image 110 was attentive to the presented visual media content 104, to facilitate generating ratings data and/or other action.

In an example implementation the computing system could determine whether or not the person 100 was attentive (e.g., whether the person was attentive or rather non-attentive), or perhaps a level of attentiveness of the person, by applying a machine-learning model that has been trained or otherwise configured to receive an input tuple of (xRotation, yRotation) of a person's direction of gaze and to output a prediction, based on that input tuple, of whether the person was attentive. Without limitation, the machine-learning model could have a decision tree architecture, defining decision nodes through which the computing system could process the input tuple, ultimately leading to output of the associated prediction.

Labeled training data could be used as a basis to train and thus configure the machine-learning model to be able to predict with a desired level of certainty whether an input tuple represents attentiveness or rather non-attentiveness. For instance, in a training phase, a computing system (perhaps the same computing system) could capture images of many test people in controlled test settings who intentionally gaze at designated points distributed inside or outside any presented visual media content.

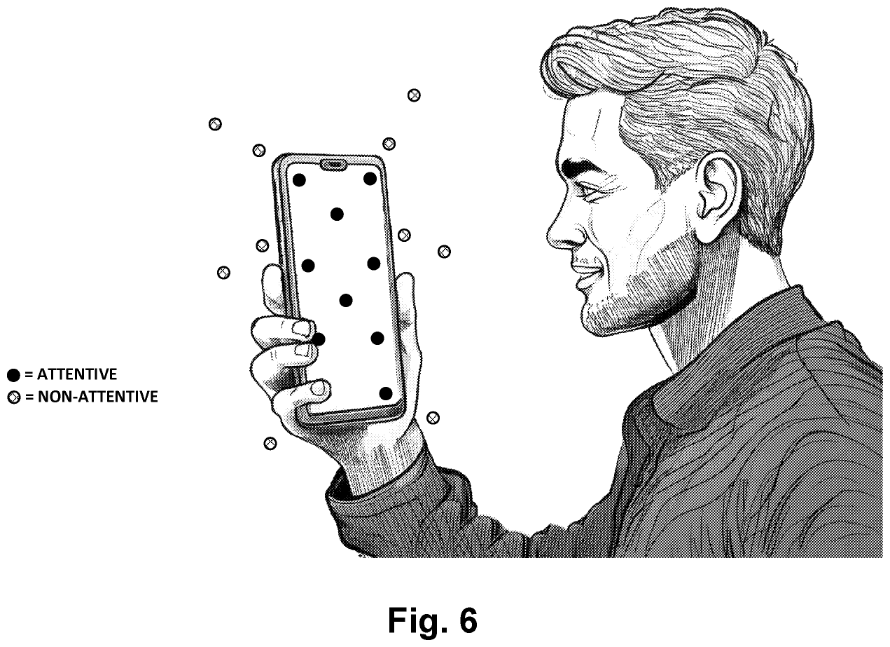

FIG. 6 illustrates examples of such points with respect to visual media content that may be presented on the example display 106 of the smartphone 102 of FIG. 1. As shown in FIG. 6, some of these points are within the frame of the display 106 of the smartphone 102, and others of these points are outside the frame of the display 106 of the smartphone 102. For each person involved with the training phase, in an example implementation, the computing system could capture an image of the person when looking respectively at each of these points and record an indication of whether the captured image represents the person being attentive or not, such as whether the point is inside the frame of the presented visual media content, with a gaze at that point thus representing attentiveness, or the point is outside the frame of the presented visual media content, with a gaze at that point thus representing non-attentiveness.

For each of these captured images, the computing system could then engage in the processing as described above for instance, to determine a respective xRotation and yRotation of the gaze of the person in the image, and the computing system could correlate the tuple (xRotation, yRotation) with the recorded indication of whether the person as depicted in the captured image was attentive or not. As a result, the computing system could establish many sets of training data, each including a respective tuple of (xRotation, yRotation) labeled as being either attentive or non-attentive.

The computing system could then programmatically plot all of these tuples as points on a grid of xRotation vs. yRotation, and the computing system could filter the data so that the quantity of attentiveness tuples is equal to the quantity of non-attentiveness tuples, so as to help avoid biasing the resulting the machine-learning model.

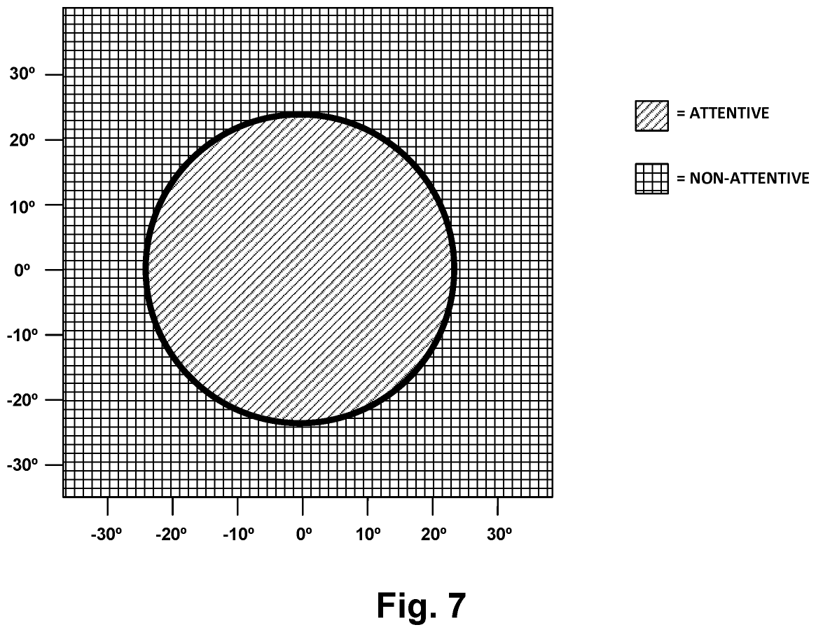

This programmatic plot may reveal that the tuples represent attentiveness when equal to or within a threshold distance from (0°, 0°) and that represent non-attentiveness when beyond that threshold distance from (0°, 0°), as shown by way of example in FIG. 7. Further, based on the physical configuration of the display 102, there may be multiple threshold distances in various directions from (0°, 0°), such, in a given direction, there is a threshold distance beyond which a tuple represents non-attentiveness, and in another given direction, there is a different threshold distance beyond which a tuple represents non-attentiveness.

The computing system may therefore configure the machine-learning model to test for the threshold distance(s) of the (xRotation, yRotation) points as a basis to predict whether the person depicted in an image was attentive or non-attentive. For instance, this may involve configuring nodes of a decision tree to successively decide whether the xRotation of an input tuple is within a given threshold and then, based on the decision at that node, to then decide whether the yRotation of the input tuple is within a given threshold, with these thresholds cooperatively establishing whether the tuple (xRotation, yRotation) is within a range that represents attentiveness or rather outside of that range and consequently represents non-attentiveness.

Training of the machine-learning model may further involve testing the model with many input tuples labeled as representing attentiveness or non-attentiveness, and determining a level of certainty (or reliability) of the model based on how well the model maps the input tuples to their labels. For instance, the computing system could determine what percentage of the labeled input tuples the model correctly mapped to their labels of attentiveness or non-attentiveness and could deem that percentage to be a level of certainty of the model. If the determined level of certainty of the model is lower than a desired level, the thresholds as defined by programmatic plotting as described above for instance could be adjusted, the model could accordingly be reconfigured, and testing could be repeated. Once the model has at least a threshold level of certainty (perhaps 80% or more, among other possibilities), the model could be considered to be successfully trained.

In an example implementation, this trained machine-learning model could be established in advance and could then be deployed on end-user devices or systems. For instance, with the above implementation involving the smartphone 102, the trained machine-learning model could be installed on the smartphone 102 to enable the smartphone 102 to readily determine whether a user of the smartphone 102 is attentive to visual media content presented on the smartphone 102. For instance, an application could be installed on the smartphone 102 and could be provisioned with a trained decision tree as discussed above, to be able to predict with a high level of certainty whether a user of the smartphone 102 is attentive to visual media content presented on the smartphone 102.

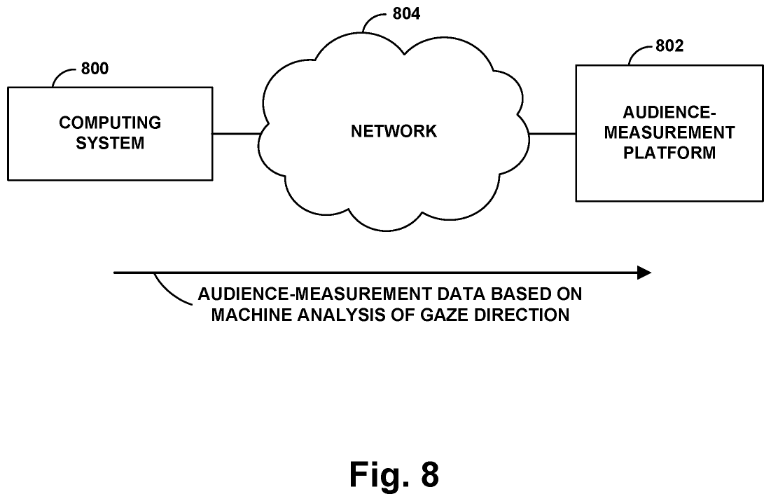

As discussed above, this arrangement can help to facilitate various useful operations. In practice, for instance, when the smartphone 102 is presenting visual media content that may be the subject of audience-measurement (e.g., if a user of the smartphone 102 is a registered panelist who has agreed to provide audience-measurement data to an audience-measurement company), the computing system of the smartphone 102 may make use of the camera 108 of the smartphone 102 and the processes discussed herein to determine whether and to what extent the user is attentive to the presented visual media content. FIG. 8 is a simplified block diagram illustrating this reporting from an example computing system 800 to an example audience-measurement platform 802 via a network 804 such as the internet.

By way of example, the computing system could periodically capture an image of the user, obtain face mesh data for the captured image, determine the associated (xRotation, yRotation) of the user, provide the (xRotation, yRotation) tuple to the trained machine-learning model, and obtain from the trained machine-learning model, based on the provided (xRotation, yRotation) tuple, a prediction of whether or not the user is attentive to the presented visual media content. The computing system could then correlate this prediction with the presented visual media content, such as by timestamping the prediction. Further, the computing system could report to a cloud-based audience-measurement platform data that correlates times of the presented visual media content with the predictions of whether or not the user was attentive to the visual media content at those times. Alternatively, the computing system could report to the platform just times when the user was predicted to be attentive to the presented visual media content, among other possibilities.

The audience-measurement platform may then use this data as a basis to control whether or not to deem certain presented visual media content to have been viewed, for purposes of establishing ratings data and/or for controlling whether to take other action. For instance, the audience-measurement platform may record that a person of given demographics viewed given presented visual media content for times when the data shows that the person was attentive to the presented visual media content, and may forgo doing so for times when the data shows that the person was not attentive to the presented visual media content.

Note also that the above process may be carried out respectively for each of various different device types, models, or other forms of visual media presentation, accounting for respective camera positioning among other factors.

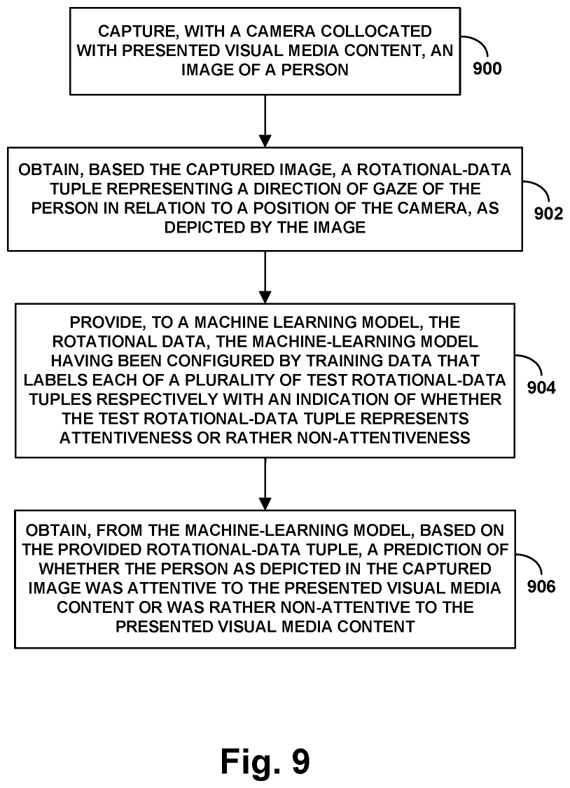

FIG. 9 is a flow chart illustrating an example computer-implemented method that could be carried out in accordance with the present disclosure. This method could be carried out by an example computing system and/or cooperatively by multiple computing systems.

As shown in FIG. 9, at block 900, the method includes capturing, with a camera collocated with presented visual media content, an image of a person. Further, at block 902, the method includes obtaining, based the captured image, a rotational-data tuple representing a direction of gaze of the person in relation to a position of the camera, as depicted by the image. Still further, at block 904, the method includes providing, to a machine-learning model, the rotational data, the machine-learning model having been configured by training data that labels each of a plurality of test rotational-data tuples respectively with an indication of whether the test rotational-data tuple represents attentiveness or rather non-attentiveness. And at block 906, the method includes obtaining, from the machine-learning model, based on the provided rotational-data tuple, a prediction of whether the person as depicted in the captured image was attentive to the presented visual media content or was rather non-attentive to the presented visual media content.

In line with the discussion above for example, the method may additionally include using the prediction as a basis for generating audience-measurement data. Further, the machine-learning model may comprise a decision tree, and the rotational-data tuple may represent the direction of gaze of the person in two Cartesian coordinates within the captured image. Still further, the act of obtaining the rotational-data tuple could involve, for a representative eye of the person as depicted in the captured image, (a) programmatically establishing a bounding box around an eyeball of the eye and (b) determining the rotational-data tuple based on (i) a center of the bounding box, (ii) a center of an iris of the eye, and (ii) a size of the bounding box. And yet further, the act of obtaining the rotational data tuple could be based on face mesh data established for the captured image.

As further discussed above for example, the visual media content could be content as presented on a display of a smartphone, and the camera could be a front-facing camera of the smartphone. Further, the method could be carried out by the smartphone. Alternatively, similar operations could be carried out with respect to other types of presentation devices and/or other contexts presentations of visual media content.

In addition, as discussed above for example, the machine-learning model may be configured by operations that include (a) for each of a plurality of test users, capturing a plurality of test images of the test user, including multiple attentiveness test images when the user is looking at presented visual media content and multiple non-attentiveness test images when the user is not looking at the presented visual media content, and (b) for each of the captured test images, determining a respective instance of the test rotational-data tuple in correlation with whether the test image is an attentiveness test image or rather a non-attentiveness test image.

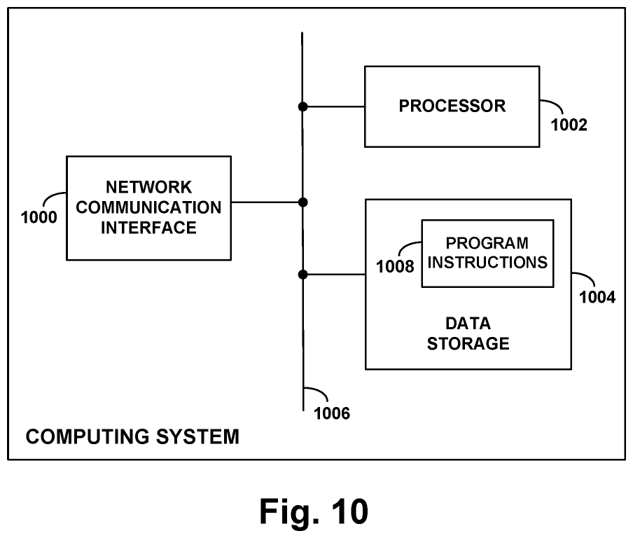

FIG. 10 is a simplified block diagram of an example computing system that could be configured to carry out various operations as described herein. This computing system, for instance, could be configured to carry out operations related to training the machine-learning model as discussed above, operations related to applying the machine-learning model to predict level of attentiveness, and/or operations related to using a prediction of level of attentiveness. Further, the computing system may also represent features of an example audience-measurement platform that may make use of attentiveness predictions as described herein.

As shown in FIG. 10, the example computing system includes at least one network communication interface 1000, at least one processor 1002, and non-transitory data storage 1004, any or all of which may be integrated together to various extents and/or communicatively linked with each other by a system bus, network, or other connection mechanism 1006.

The network communication interface 1000 may comprise one or more wired and/or wireless network communication modules along with associated drivers and/or other logic, to enable communication over a network. For instance, the network communication interface 1000 may include a wired and/or wireless Ethernet adapter along with associated program logic.

The processor 1002 may comprise one or more general purpose processors (e.g., microprocessors) and/or one or more specialized processors (e.g., digital signal processors (DSPs), graphics processing units (GPUs), neural processing units (NPUs), etc.) Further, the non-transitory data storage 1004 may comprise one or more volatile and/or non-volatile storage components (e.g., flash, optical, magnetic, ROM, RAM, EPROM, EEPROM, etc.), which may be integrated in whole or in part with the processor 1002. As further shown, the non-transitory data storage 1004 could store program instructions 1008, which may be executable by the processor 1002 to carry out (i.e., cause the computing system to carry out) various computing system operations described herein.

The present disclosure contemplates at least one non-transitory computer-readable medium (e.g., one or more volatile and/or non-volatile storage components, such as magnetic, optical, flash, RAM, ROM, EPROM, EEPROM, etc.) having stored thereon program instructions executable by at least one processor to carry out or cause to be carried out various disclosed operations.

Example embodiments have been described above. Those skilled in the art will understand, however, that changes and modifications may be made to these embodiments without departing from the true scope and spirit of the invention.

We claim:

1. A computer-implemented method comprising:
capturing, with a camera collocated with presented visual media content, an image of a person;
obtaining, based the captured image, a rotational-data tuple representing a direction of gaze of the person in relation to a position of the camera, as depicted by the image;
providing, to a machine-learning model, the rotational data, wherein the machine-learning model has been configured by training data that labels each of a plurality of test rotational-data tuples respectively with an indication of whether the test rotational-data tuple represents attentiveness or rather non-attentiveness; and
obtaining, from the machine-learning model, based on the provided rotational-data tuple, a prediction of whether the person as depicted in the captured image was attentive to the presented visual media content or was rather non-attentive to the presented visual media content.

2. The computer-implemented method of claim 1, further comprising using the prediction as a basis for generating audience-measurement data.

3. The computer-implemented method of claim 1, wherein the machine-learning model comprises a decision tree.

4. The computer-implemented method of claim 1, wherein the rotational-data tuple represents the direction of gaze of the person in two Cartesian coordinates within the captured image.

5. The computer-implemented method of claim 1, wherein obtaining the rotational-data tuple comprises, for a representative eye of the person as depicted in the captured image:
programmatically establishing a bounding box around an eyeball of the eye;
determining the rotational-data tuple based on (i) a center of the bounding box, (ii) a center of an iris of the eye, and (ii) a size of the bounding box.

6. The computer-implemented method of claim 1, wherein the visual media content is presented on a display of a smartphone, and wherein the camera is a front-facing camera of the smartphone.

7. The computer-implemented method of claim 6, wherein the computer-implemented method is carried out by the smartphone.

8. The computer-implemented method of claim 1, wherein obtaining the rotational-data tuple is based on face mesh data established for the captured image.

9. The computer-implemented method of claim 1, wherein the machine-learning model has been configured by operations comprising:
for each of a plurality of test users, capturing a plurality of test images of the test user, including multiple attentiveness test images when the user is looking at presented visual media content and multiple non-attentiveness test images when the user is not looking at the presented visual media content;
for each of the captured test images, determining a respective instance of the test rotational-data tuple in correlation with whether the test image is an attentiveness test image or rather a non-attentiveness test image.

10. A computing system comprising:
at least one processor;
non-transitory data storage; and
program instructions stored in the non-transitory data storage and executable by the at least one processor to cause the computing system to carry out operations comprising:
capturing, with a camera collocated with presented visual media content, an image of a person,
obtaining, based the captured image, a rotational-data tuple representing a direction of gaze of the person in relation to a position of the camera, as depicted by the image,
providing, to a machine-learning model, the rotational data, wherein the machine-learning model has been configured by training data that labels each of a plurality of test rotational-data tuples respectively with an indication of whether the test rotational-data tuple represents attentiveness or rather non-attentiveness, and
obtaining, from the machine-learning model, based on the provided rotational-data tuple, a prediction of whether the person as depicted in the captured image was attentive to the presented visual media content or was rather non-attentive to the presented visual media content.

11. The computing system of claim 10, wherein the operations additionally include using the prediction as a basis for generating audience-measurement data.

12. The computing system of claim 10, wherein the machine-learning model comprises a decision tree.

13. The computing system of claim 10, wherein the rotational-data tuple represents the direction of gaze of the person in two Cartesian coordinates within the captured image.

14. The computing system of claim 10, wherein obtaining the rotational-data tuple comprises, for a representative eye of the person as depicted in the captured image:
establishing a bounding box around an eyeball of the eye;
determining the rotational-data tuple based on (i) a center of the bounding box, (ii) a center of an iris of the eye, and (ii) a size of the bounding box.

15. The computing system of claim 10, wherein the visual media content is presented on a display of a smartphone, and wherein the camera is a front-facing camera of the smartphone.

16. The computing system of claim 15, wherein the computing system is disposed at the smartphone.

17. The computing system of claim 10, wherein obtaining the rotational-data tuple is based on face mesh data established for the captured image.

18. The computing system of claim 10, wherein the machine-learning model has been configured by operations comprising:
for each of a plurality of test users, capturing a plurality of test images of the test user, including multiple attentiveness test images when the user is looking at presented visual media content and multiple non-attentiveness test images when the user is not looking at the presented visual media content;
for each of the captured test images, determining a respective instance of the test rotational-data tuple in correlation with whether the test image is an attentiveness test image or rather a non-attentiveness test image.

19. Non-transitory data storage having stored program instructions executable by at least one processor of a computing system to cause the computing system to carry out operations comprising:
capturing, with a camera collocated with presented visual media content, an image of a person;
obtaining, based the captured image, a rotational-data tuple representing a direction of gaze of the person in relation to a position of the camera, as depicted by the image;
providing, to a machine-learning model, the rotational data, wherein the machine-learning model has been configured by training data that labels each of a plurality of test rotational-data tuples respectively with an indication of whether the test rotational-data tuple represents attentiveness or rather non-attentiveness; and
obtaining, from the machine-learning model, based on the provided rotational-data tuple, a prediction of whether the person as depicted in the captured image was attentive to the presented visual media content or was rather non-attentive to the presented visual media content.

20. The non-transitory data storage of claim 19, wherein the operations additionally comprise using the prediction as a basis for generating audience-measurement data.
